(19) United States
(12) Patent Application Publication
(10) Pub. No.: US 2017/0228768 A1
(43) Pub. Date: Aug. 10, 2017

(54) ATTRIBUTING CONVERSIONS RELATING TO CONTENT ITEMS

(71) Applicant: Google Inc., Mountain View, CA (US)

(72) Inventors: Shobhit Saxena, Mountain View, CA (US); Vinod Kumar Ramachandran, Mountain View, CA (US); Yu Yan, Mountain View, CA (US); Philip McDonnell, Mountain View, CA (US); Anshul Gupta, Mountain View, CA (US); Joseph Lee, Mountain View, CA (US); Sachin Kulkarni, Mountain View, CA (US)

(21) Appl. No.: 15/284,816

(22) Filed: Oct. 4, 2016

Related U.S. Application Data
(60) Provisional application No. 62/293,108, filed on Feb. 9, 2016.

(51) Int. Cl. G06Q 30/02; H04L 29/08

(52) U.S. Cl. CPC G06Q 30/0246; H04L 67/22

(57) ABSTRACT

A method, includes receiving a first data packet with transaction data representing a transaction of a user at a storefront. The transaction data is parsed and decrypted to obtain a first identifier. The method further includes receiving a second data packet with interaction data representing an interaction with a content item on a resource. A log file is created that indexes the interaction data, including a second identifier. The transaction data and interaction data are compared, and it is determined if the first identifier and the second identifier are both associated with the user. The method further includes attributing the transaction at the storefront to the interaction of the user with the content item in response to the determination that the first identifier and the second identifier are both associated with the user. Conversion data is generated and stored indicating the attribution.

### CROSS-REFERENCE TO RELATED APPLICATIONS

This application claims the benefit of and priority to U.S. Application No. 62/293,108, filed Feb. 9, 2016, incorporated herein by reference in its entirety.

### BACKGROUND

In a networked environment, such as the Internet, first-party content providers can provide information to user devices for presentation on resources, such as webpages, mobile applications, documents, other applications, and/or other resources. Additional third-party content can also be provided by third-party content providers for presentation on the user devices, for example, together with the information from the first-party content providers. A publisher may provide first-party content and third-party content on his or her resource. One challenge for a third-party content provider is determining the effectiveness of third-party content.

Conversion tracking (e.g., determining if a user exposed to a content item performed a conversion, such as purchasing a product/service, providing requested information, etc.) for a third-party content item often is performed using browser cookies. This generally works best when users are using a single browser and single device to interact with content. Cookie-based conversion tracking is more complex when a user uses multiple devices and/or browsers, resulting in some losses (e.g., not being able to track some conversions). This approach has even more losses when tracking offline conversions, such as a purchase in a store.

### SUMMARY

One implementation of the present disclosure relates to a method. The method includes receiving, by one or more processors, a first data packet embedding transaction data representing a transaction of a user at a storefront of a content provider and including encrypted information associated with the user. The method further includes parsing, by the one or more processors, the first data packet to extract the embedded transaction data and decrypting, by the one or more processors, the encrypted information to obtain a first identifier for the transaction. The method further includes receiving, by the one or more processors, a second data packet embedding interaction data including a content item identifier, a resource identifier indicating a resource on which the content item was presented, a type of interaction, and a second identifier associated with a user device of the user. The method further includes creating, by the one or more processors, a log file indexing the interaction data from the second data packet. The method further includes comparing, by the one or more processors, the decrypted transaction data and the second identifier indexed in the log file. The method further includes determining, by the one or more processors, based on the comparison, that the first identifier and the second identifier are both associated with the user. The method further includes attributing, by the one or more processors, the transaction at the storefront to the interaction of the user with the content item in response to the determination that the first identifier and the second identifier are both associated with the user. The method further includes generating and storing, by the one or more processors, conversion data embedding data indicating attribution of the transaction at the storefront to the interaction of the user with the content item, and the content item.

Another implementation of the present disclosure relates to a system including at least one computing device operably coupled to at least one memory. The system is configured to receive a first data packet embedding transaction data representing a transaction of a user at a storefront of a content provider and including encrypted information associated with the user. The system is further configured to parse the first data packet to extract the embedded transaction data and decrypt the encrypted information to obtain a first identifier for the transaction. The system is further configured to receive a second data packet embedding interaction data including a content item identifier, a resource identifier indicating a resource on which the content item was presented, a type of interaction, and a second identifier associated with a user device of the user. The system is further configured to create a log file indexing the interaction data from the second data packet. The system is further configured to compare the decrypted transaction data and the second identifier indexed in the log file. The system is further configured to determine, based on the comparison, that the first identifier and the second identifier are both associated with the user. The system is further configured to attribute the transaction at the storefront to the interaction of the user with the content item in response to the determination that the first identifier and the second identifier are both associated with the user. The system is further configured to generate and store conversion data embedding data indicating attribution of the transaction at the storefront to the interaction of the user with the content item, and the content item.

Yet another implementation of the present disclosure relates to one or more computer-readable storage media having instructions stored thereon that, when executed by one or more processors, cause the one or more processors to execute operations. The operations include receiving a first data packet embedding transaction data representing a transaction of a user at a storefront of a content provider and including encrypted information associated with the user. The operations further include parsing the first data packet to extract the embedded transaction data and decrypting the encrypted information to obtain a first identifier for the transaction. The operations further include receiving a second data packet embedding interaction data including a content item identifier, a resource identifier indicating a resource on which the content item was presented, a type of interaction, and a second identifier associated with a user device of the user. The operations further include creating a log file indexing the interaction data from the second data packet. The operations further include comparing the decrypted transaction data and the second identifier indexed in the log file. The operations further include determining, based on the comparison, that the first identifier and the second identifier are both associated with the user. The operations further include attributing the transaction at the storefront to the interaction of the user with the content item in response to the determination that the first identifier and the second identifier are both associated with the user. The operations further include generating and storing conversion data embedding data indicating attribution of the transaction at the storefront to the interaction of the user with the content item, and the content item.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description and the drawings.

FIG. 1 is a block diagram of an offline conversion system and associated environment according to an illustrative implementation.

FIG. 2 is a detailed block diagram illustrating a process of determining conversions for a plurality of content items based on transaction data according to an illustrative implementation.

FIG. 3 is a detailed block diagram illustrating a process of estimating conversions according to an illustrative implementation.

FIG. 4 is a detailed diagram illustrating a relationship between a set of user interactions with content items and a set of user transactions according to an illustrative implementation.

FIG. 5 is a flow diagram of a process for attributing a plurality of conversions to a plurality of user interactions with a content item according to an illustrative implementation.

FIG. 6 is a flow chart of a process for extrapolating conversion data to estimate a number of conversions attributable to a plurality of user interactions with a content item according to an illustrative implementation.

FIG. 7 is a block diagram of a computing system according to an illustrative implementation.

### DETAILED DESCRIPTION

Following below are more detailed descriptions of various concepts related to, and implementations of, methods, apparatuses, and systems for providing information using a computer network. The various concepts introduced above and discussed in greater detail below may be implemented in any of numerous ways as the described concepts are not limited to any particular manner of implementation. Examples of specific implementations and applications are provided primarily for illustrative purposes.

Referring generally to the figures, systems and methods for detecting offline conversions is shown and described. One method generally includes receiving transaction data from a content provider relating to offline transactions, such as transactions at a physical storefront of a content provider). The transaction data may include, for example, hashed personally identifiable information (PII), or other such information that may be used to identify a user associated with a transaction. By hashing the transaction data, the identity and/or other characteristics of a user to whom the transaction data relates cannot be identified without the hash key. The content provider may also provide transaction data for which some transaction data may not be determinable (e.g., PII).

The method further includes receiving user interaction data for one or more content items, which may be displayed on one or more resources (e.g., webpages). The content items may be associated with the transactions at the physical storefront of the content provider. The method further includes comparing the transaction data with the user interaction data for one or more content items of the content provider. The transaction data may include an email address or other identifier that identifies a particular user account associated with a transaction. The user interaction data may generally include an identifier indicating a particular user account associated with an interaction with a content item (e.g., an impression of the content item on a resource, a click on the content item, etc.). By comparing the transaction data and user interaction data, the method may identify conversion data which indicates a number of users who had a transaction and an interaction with a content item which can be associated with the transaction. The comparison indicates a number of users that were identifiable at “click time” (when the user interacted with a content item) and at “conversion time” (at the time of transaction).

The method may further include extrapolating the conversion data. Not all users may be identifiable at the time of a transaction, and not all users who viewed an impression of a content item may be identifiable. Therefore, extrapolation of the conversion data may be used to estimate the number of impressions of a content item that led to a transaction, for users who were not identifiable.

Probabilities of several events may be used to extrapolate the conversion data. First, for all interactions with a content item (e.g., clicks or impressions), a probability αᵢ that a user was “signed-in” or otherwise identifiable during the interaction can be determined. A second probability β is determined that represents a probability that a “signed-in” interaction has a corresponding store visit and store transaction. A third probability γ is determined that represents the probability that the user was identifiable at the time of the transaction (e.g., via a loyalty card or other identifying information). The number of observed conversions should be equal to αᵢ*β*γ *clicksᵢ, where clicksᵢ is a total number of user interactions with a content item.

As one example of extrapolating the conversion data, estimating total store sales conversions may be accomplished by applying a blow-up factor to the number of observed conversions. The blow-up factor represents a fraction of users who were not identifiable based on the comparison of the transaction data and user interaction data. The blow-up factor may be adjusted based on, for example: (1) a sign-in rate of all users who interacted with a content item on a resource; (2) an identified transaction rate that identifies a percentage of users that were identifiable at the time of a transaction; and (3) a rate of users who were not identifiable at any time during the conversion process.

In situations in which the systems discussed here collect and/or personal information about users, or may make use of personal information, the users may be provided with an opportunity to control whether programs or features collect user information (e.g., information about a user's social network, social actions or activities, a user's preferences, or a user's current location), or to control whether and/or how to receive content from the content selection server that may be more relevant to the user. In addition, certain data may be anonymized in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content selection server. Further, the individual user information itself is not surfaced to the content provider, so the content provider cannot discern the interactions associated with particular users.

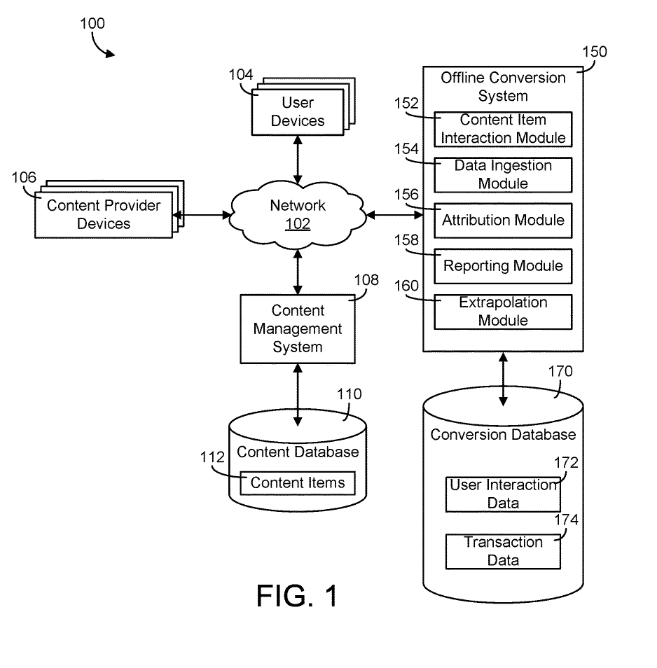

Referring now to FIG. 1, and in brief overview, a block diagram of an offline conversion system 150 and associated environment 100 is shown according to an illustrative implementation. One or more user devices 104 may be accessed by a user to perform various actions and/or access various types of content, some of which may be provided over a network 102 (e.g., the Internet, LAN, WAN, etc.). For example, user devices 104 may be used to access webpages (e.g., using an Internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content items from which content management system 108 selects for display may be provided by one or more content providers via network 102 using one or more content provider devices 106. In some implementations, bids for content to be selected by content management system 108 may be provided to content management system 108 from content providers participating in an auction. In such implementations, content management system 108 may determine content to be published in one or more content interfaces of resources (e.g., webpages, applications, etc.) shown on user devices 104 based at least in part on the bids.

An offline conversion system 150 may be configured to determine offline conversions (e.g., conversions in a physical storefront) related to interactions with one or more content items on a webpage or other resource. An interaction with a content item may include viewing the content item on the resource, clicking a content item or otherwise interacting with the content item on the resource (e.g., a hover event), completing a specific action after interacting with the content item, such as making a purchase and/or providing requested information, and the like. In some implementations, the user may complete an action after interacting with or viewing a content item; which may be an “offline” action occurring away from the webpage or resource. Examples of offline actions may include, but are not limited to, purchasing a product in an offline setting, such as a physical storefront, or purchasing a product from a website or other online resource where the offline conversion system 150 cannot directly detect the actions taken. Offline conversion system 150 may generally be configured to determine the occurrence of a conversion by receiving an offline action and attributing a previous interaction with a content item to the offline action.

Referring in greater detail to FIG. 1, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may include a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a webpage, search engine provider, etc.) or executing a first-party application. Content management system 108 may use any number of factors to determine the winner of the auction (e.g., selecting a winner of a content auction based on a third-part content provider's bid and/or a quality score for the third-party provider's content).

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's resource. In other words, a bid amount may be a cost per click (CPC) bid amount. In another example, the bid amount may correspond to an action being performed on the third-party provider's resource, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content item is to be presented in conjunction with search results from a search engine, for example, the selection parameters may include one or more sets of search keywords. Other illustrative parameters that control when a bid is placed on behalf of a third-party content provider may include, but are not limited to, a topic identified using a device identifier's history data (e.g., based on resources visited by the device identifier), the topic of a resource or other first-party content with which the third-party content is to be presented, a geographic location of the client device that will be presenting the content, or a geographic location specified as part of a search query. In some cases, a selection parameter may designate a specific resource or resources with which the third-party content is to be presented.

As described above, an offline conversion system 150 is configured to identify offline conversions related to an interaction with one or more content items. A conversion is a desired action taken by a user after the user is presented with a content item on a resource. For example, a conversion may occur when the user clicks or interacts with a content item and eventually completes a purchase of a product or service related to the content item and interaction. In some implementations, a content provider may define one or more actions that constitute a conversion (e.g., actions the content provider wishes for the user to take, such as making a purchase or providing information to the content provider). Offline conversion system 150 detects conversions that occur offline (e.g., conversions that take place after an interaction with a content item, the conversion taking place in a different location or resource than from where the interaction with the content item occurred). The offline conversion may take place for a content item displayed on a webpage at, for example, a physical store. Environment 100 may further include a system for detecting online conversions (e.g., conversions that occur when a user interacts with a content item and completes an action on a webpage or other resource).

Offline conversion system 150 is shown to include a content item interaction module 152 generally configured to determine a user interaction with a content item displayed on a resource. The user interaction may be an impression (e.g., the user viewing the content item), or a click or other similar interaction with the content item (e.g., the user clicking on a content item to expand the content item, view video, listen to audio, open a new webpage related to the content item, etc.). Content item interaction module 152 may store the user interaction in a conversion database 170 as user interaction data 172.

Offline conversion system 150 is shown to include a data ingestion module 154 configured to receive transaction data from a plurality of sources. In some implementations, data ingestion module 154 may receive transaction data from one or more content provider devices 106. For example, for a particular content provider, transaction data relating to sales by the content provider in a physical or online store may be transmitted to data ingestion module 154. Data ingestion module 154 may generally be configured to receive the transaction data, format the transaction data, and store the transaction data (shown as transaction data 174 in FIG. 1) in conversion database 170 for temporary storage.

Offline conversion system 150 is shown to include an attribution module 156 configured to attribute transaction data 174 to user interaction data 172. Attribution module 156 attributes transaction data 174 for a particular transaction to a particular user interaction with a content item, to determine if an interaction with a content item led to a transaction. Offline conversion system 150 is further shown to include a reporting module 158 configured to generate a report for a content provider. The content provider report may relate to attributed offline conversions for a content item provided for display on resources by the content provider, as determined by attribution module 156.

Offline conversion system 150 is shown to include an extrapolation module 160. Extrapolation module 160 may be configured to estimate a number of offline conversions for a particular content item. For example, some transaction data or interaction data may not include an identifier associated with the transaction or interaction. Therefore, some transaction data and interaction data may not be attributable to each other by attribution module 156. Extrapolation module 160 may estimate conversions for transaction data and interaction data that is not attributable. The extrapolated conversion data may then be included as part of the report to the content provider by reporting module 158.

Conversion database 170 may generally be configured to store user interaction data 172 and transaction data 174. In some implementations, conversion database 170 may be configured to only store recent user interaction data 172 and transaction data 174, and may delete old data. While conversion database 170 is shown as a single database; in various implementations, environment 100 may include any number of data storage devices configured to store data in any type of format.

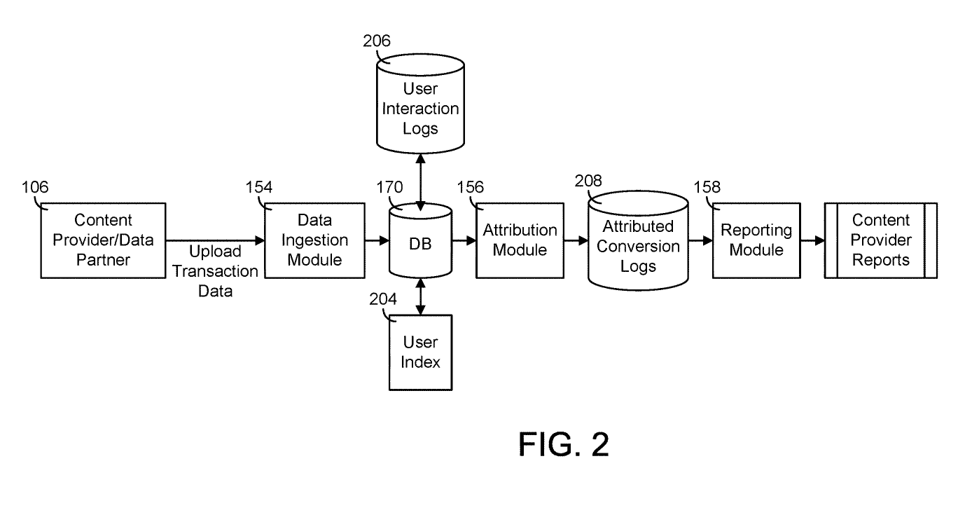

Referring now to FIG. 2, various features of offline conversion system 150 are shown in greater detail according to an illustrative implementation. The features of offline conversion system 150 may generally include data ingestion, attribution, and reporting, as described in FIG. 1. The interaction between the various systems, content providers, and databases are shown in greater detail in FIG. 2.

Data ingestion module 154 is shown to receive transaction data from a content provider 106 (or other data partner) uploading the data. In some implementations, the transaction data may be formatted by the content provider to allow data ingestion module 154 to process the data. Content provider 106 may upload the file to offline conversion system 150 via a file transfer or any other method, and may upload the file at a fixed frequency (e.g., upload a new file every week, every month, every two months, etc.) or a variable frequency (e.g., upon request from offline conversion system 150, after a threshold number of transactions has been reached, etc.).

In some implementations, the transaction data is transmitted in a CSV file. The fields of the CSV file may include a hashed identifier (e.g., a hashed email address) such that the identifier that could be used to determine a particular user relating to the data is coded for privacy. In some implementations, the content provider may use SHA-256 for hashing the identifier. In some implementations, the fields may include a transaction date and a transaction date timezone from which data ingestion module 154 may set transaction dates for all transactions to a common timezone for further processing. In some implementations, the fields may further include a transaction amount and transaction currency specifying an amount spent in a transaction. Data ingestion module 154 may convert the transaction amounts to the same currency for further processing. The fields may further include a label field, which may be a free form field for providing further information relating to the transaction. In some implementations, the information in the label field may be used to help match the conversion data to user interaction data.

Data ingestion module 154 may store the transaction data in a database 170, in some implementations. Database 170 may be configured to store transaction data for a period of time (e.g., one month, three months, one year, etc.). As one example, database 170 may store transaction data for three months before deleting the data. This may generally allow offline conversion system 150 to only attribute recent transactions to recent content item interactions. In one example, offline conversion system 150 may wish to determine a thirty-day attribution (i.e., attributing a content item interaction with a transaction that occurred in the last thirty days). Database 170 may be configured to store transaction data from the last three months as a buffer. In general, offline conversion system 150 may generate a report for a number of attributions within a time period, which indicates a number of conversions that occurred within a given time period (e.g., a number of times a user interacted with a content item and then subsequently completed a transaction within a given time period). These time periods may be set to avoid attribution of a transaction to a content item interaction when the time in between the interaction and transaction is large (e.g., more than one month, more than three months, etc.). Database 170 may be configured to store different data for different amounts of time, according to various content provider preferences, transaction types, or the like.

Data ingestion module 154 may receive metadata from content provider 106 or other data partner, in some implementations. The metadata may allow offline conversion system 150 to perform extrapolations to allow the system to account for transaction data and user interaction data that cannot be correlated with one another. The metadata may include an identified transaction rate. The identified transaction rate may be a fraction of total transactions that can be identified by a valid identifier over a period of time (e.g., 30 days). The valid identifier may be, for example, an email address. In one implementation, content provider 106 may provide the total number of store transactions over the given time period, and data ingestion module 154 may determine the number of transactions associated with a valid identifier based on the data provided. In some implementations, the identifier may be hashed, as described above, so that offline conversion system 150 can identify data relating to a same user without having access to actual identifying information for the user.

Database 170, as described above, may further store user interaction data representative of user interactions with one or more content items associated with a content provider. Database 170 may receive user interaction data from one or more user interaction logs 206 configured to store the user interaction data and to transmit the data to database 170. In various implementations, user interaction logs 206 may store user interactions over a period of time and may transmit the user interaction data to database 170 at a fixed or variable rate.

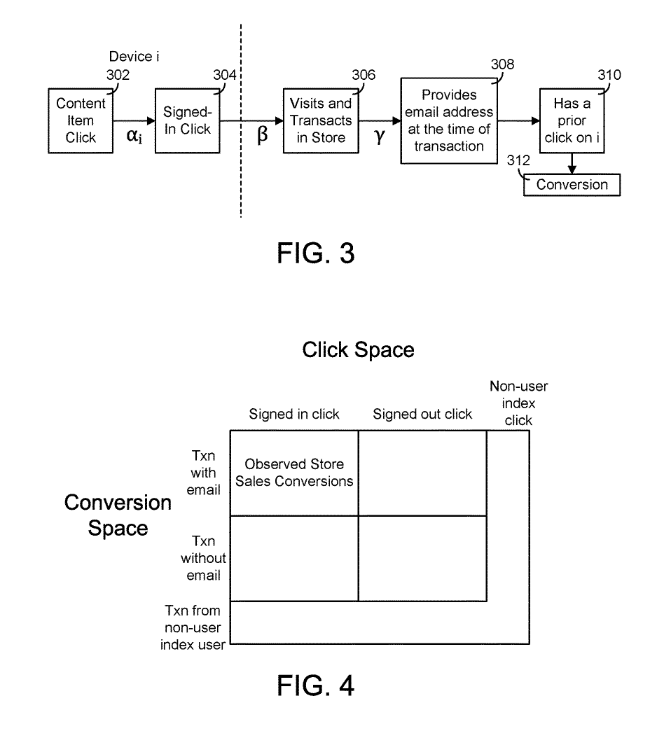

Database 170 may further receive data from a user index 204. For example, for a given resource (e.g., webpage), a user index 204 may identify a number of users who are identifiable (e.g., users who have an account, an email address, or other identifier). Further, user index 204 may be used by attribution module 156 to identify a user associated with a particular content item interaction. The user index 204 data may include metadata such as an identifier adoption rate, in some implementations. The identifier adoption rate may be the proportion of users in the total population (e.g., all users that access a particular resource, or all users having an interaction with a content item displayed on a webpage) that actively use an identifier. In some implementations, the identifier is an email address and the identifier adoption rate identifies a percentage of users who have a valid email address. In some implementations, the identifier adoption rate may be refreshed every week, every month, four times a year, etc., as the rate is unlikely to change greatly over a short period of time. The metadata and the extrapolation process using the metadata is described in greater detail with respect to FIG. 3 according to an illustrative implementation.

Attribution module 156 joins the transaction data with user interaction data (e.g., with the clicks on content items on a webpage). In some implementations, attribution module 156 compares the identifiers in the transaction data with identifiers in the user interaction data to determine a match between a particular transaction and a one or more particular user interactions. Attribution module 156 may store a plurality of determined conversions in an attributed conversion log 208.

Reporting module 158 may generate attribution reports for content providers based on the information stored in attributed conversion logs 208. The attribution report may generally include the following fields: campaign identifier, click date, conversion date, click platform (or other user interaction platform), country (or other location information), and conversion label. The campaign identifier field may identify a campaign with which the content item of the attribution is associated. The click date and conversion date fields may identify the time of the user interaction and transaction, respectively. The click platform field may identify a browser, webpage, or other information relating to the user interaction. The country field may identify a location of the user associated with the attribution. The conversion label field may identify any other information associated with the attribution. In some implementations, reporting module 158 may generate aggregated reports providing aggregated information about multiple conversions/interactions (e.g., multiple conversions relating to a single campaign or set of campaigns, multiple conversions occurring over a timeframe, etc.) instead of or in addition to reports identifying information for particular conversions.

Offline conversion system 150 may include various privacy filters for filtering information from the transaction data and user interaction data, according to illustrative implementations. For example, for a given transaction, the content provider may not be allowed to obtain an identity of the user or information the content provider could use to determine the identity of the user.

The privacy considerations may include conversion date based filtering. For example, where the number of valid identifiers uploaded is greater than a threshold number (e.g., one hundred), reporting module 158 may skip reporting for conversion dates where the number of conversions less than ten (e.g., skipping reporting attributions for a particular content item when few users interacted with the content item). The privacy considerations may further include click date based filtering. For example, for a click date to be reported as having more than one conversion, the number of unique users interacting with a content item on that date may be required to be greater than a threshold value (e.g., greater than ten). This helps prevent content providers from knowing which user interacted with the content item.

Referring now to FIG. 3, a process of estimating conversions using metadata is shown in greater detail according to an illustrative implementation. In addition to determining a number of conversions, as described in FIG. 2, offline conversion system 150 may estimate a further number of conversions to more accurately determine the effectiveness of content item impressions.

As described above, content providers may provide transaction data to offline conversion system 150 for attribution to user interaction data. Two types of data loss may occur during the attribution: users may not be identifiable at the time of an interaction with the content item (e.g., the user is not signed in to an email account at the time), and users may not be identifiable at the time of a transaction (e.g., the user does not provide an email address, a loyalty card or other ID, etc.). In the first type of data loss, offline conversion system 150 is unable to attribute a content item interaction to a transaction. In the second type of data loss, offline conversion system 150 is unable to attribute a transaction to a content item interaction. Offline conversion system 150 may estimate these losses using metadata transmitted by the content provider, in some implementations.

FIG. 3 illustrates a Markov chain (i.e., an event chain), where each state transition in the Markov chain represents a set transformation with a transition probability governed by an action taken by the user, according to an illustrative implementation. For example, the transition between a click and a signed-in click is governed by the user action of signing in. FIG. 3 illustrates the steps to be taken by a user in order for offline conversion system 150 to have sufficient information to attribute a conversion event to a content item interaction.

The probabilities shown in FIG. 3 represent the following over a population sample:

αᵢ=probability of a signed-in click on a device i=number of signed-in clicks/total clicks. This variable represents the probability that a given interaction with a content item can be associated with a user identifier;
β=probability that the signed-in click has a corresponding store visit and store transaction from the same user. This variable represents the odds that a user that had an interaction with a content item will eventually perform a conversion event;
γ=probability that the transacting user is identifiable (e.g., uses a loyalty card, provides an email address or other identifier, etc.). This can be estimated based on what fraction of the store transactions uploaded from the content providers have an associated email address (or other identifier). The probability may be dependent upon the location (e.g., country) of the transaction and the content provider.

As shown in FIG. 3, at block 302, a content item click (or other interaction with a content item) is detected. At block 304, it is determined whether the click or other interaction was a signed-in click (e.g., the user was signed-in to an account when clicking the content item). Based on the total number of clicks and a number of identifiable clicks, the probability αᵢ is determined.

At block 306, a transaction in a physical storefront is detected, the transaction related to the content item. Based on the total number of transactions and the total number of content item clicks, the probability β is determined. At block 308, transactions with an associated user identifier are detected. Based on the total number of transactions and the number of identifiable transactions, the probability γ is determined. Then, at blocks 310 and 312, the attribution process as described above correlates the content item clicks to the transactions.

As the result of the various types of data loss as illustrated in FIG. 3, the number of observed store conversions SVᵢ attributed to a click on the platform i can be represented as SVᵢ=αᵢ*β *γ *clicksᵢ.

It can be assumed that the event of the user being signed in at the time of the click or other user interaction with a content item is independent of the event of the user providing an email address or other identifier at the time of the transaction. For estimating total store sales conversions SVᵢ, a blow-up factor can be used that sets some of the parameters of the above equation to 1. For example, using a blowup factor of 1/αᵢγ is equivalent to estimating total store sales conversions if every click is signed-in and all transactions have an email address associated with them. Hence the estimated store sales conversions can be written as:

$${\hat{SV}}_{i} = {θ}_{i} ⋆ {SV}_{i} = \frac{1}{{α}_{i} γ}$$

where 1/αᵢγ is the blow-up factor.

The blow-up factor does not take into consideration fraction bias associated with the user index. FIG. 4 illustrates a click and conversion space representing a total number of clicks and total number of conversions, respectively, according to an illustrative implementation. In other words, the diagram of FIG. 4 illustrates the total number of user interactions (described as clicks on content items in FIG. 4) and conversions (e.g., transactions), and how the two sets may relate to each other. For example, the click space may include signed-in clicks (content item interactions where the user is identifiable), signed-out clicks (content item interactions where the user has an account but is not identifiable at the time), and non-user index clicks (content item interactions from users who do not have an account). Similarly, the conversion space may include transactions with an associated email (or other identifier), transactions where the user has an identifiable email address but does not provide the email address, and transactions where the user does not have an identifiable email address. Only situations where the interaction was a signed-in click and the transaction included an email address can lead to a attribution; for all other cases a total number of attributions should be estimated.

The implementation shown in FIG. 4 described a click on a content item as the content item interaction, a conversion as the transaction event, and an email address as the user identifier. In other implementations, other designations are possible as generally described in the present disclosure.

The blow-up factor may extrapolate to account for the various factors illustrated in FIG. 4. One example factor is the click time sign in rate, which is a rate of how many users who clicked a content item and have an identifier were signed in (i.e., identifiable) at the time of the click on the content item. This can be computed as:

$$\frac{signed in {clicks}_{i}}{user index {clicks}_{i}} = \frac{{C}_{i}}{{ℊ}_{i}}$$

where gᵢ is the user traffic platform for platform i (e.g., a particular webpage or resource) and Cᵢ is a click sign-in rate with the denominator being all clicks on the content item from all users (not just clicks from identifiable users or users in a user index).

Another illustrative factor is an identified transaction rate (e.g., the conversion time rate). This can be computed as:

$$\frac{\# Txn with email}{\# Txn from email users} = \frac{I T R}{em}$$

where ITR is the identified transaction rate calculated from

$$\frac{\# Txn with email}{\# Total Txn}$$

and em is an email adoption rate (e.g., an email adoption rate for a region, such as for the relevant country). The email adoption rate may generally be representative of how many people in a given area have chosen to be identifiable to offline conversion system 150. The identified transaction rate identifies how likely a user is identifiable during a transaction event, given that the user has an identifier recognizable by offline conversion system 150.

Another illustrative factor is a user index to non-user index rate. For example, some users may simply not have any identifier that can be detected by offline conversion system 150 (e.g., no identifier stored in the user index). This factor results in offline conversion system 150 needing to extend from observed store sales conversions to store sales conversions in the user space of the user index. In order to extrapolate to non-user index users, gᵢ can be used for the click platform as this extrapolation should be for the user space that has clicked on the content items on platform i. Therefore, the store sales conversion blow-up factor can be defined as:

$${θ}_{i} = \frac{1}{\frac{{C}_{i}}{{ℊ}_{i}}} ⋆ \frac{1}{\frac{I T R}{em}} ⋆ \frac{1}{{ℊ}_{i}} = \frac{em}{{C}_{i} ⋆ I T R}$$

where the following values may be used to complete the blowup factor: click sign-in rate for a platform, identified transaction rate, and email adoption rate, which are described above. In some implementations, the user index fraction may be used as an alternative to the email adoption rate.

The methodology of FIGS. 3-4 makes some assumptions in some implementations. For example, it may be assumed that conversion rates for users in the user index and users not in the user index are similar. In some implementations, an email adoption rate may be computed from a country (or other locale) population to compute transacting users capable of giving an email address at the time of transaction. This might be different than the country level user space. In some implementations, it may be assumed that conversion rates are similar for users who are signed in at click time and signed out at click time.

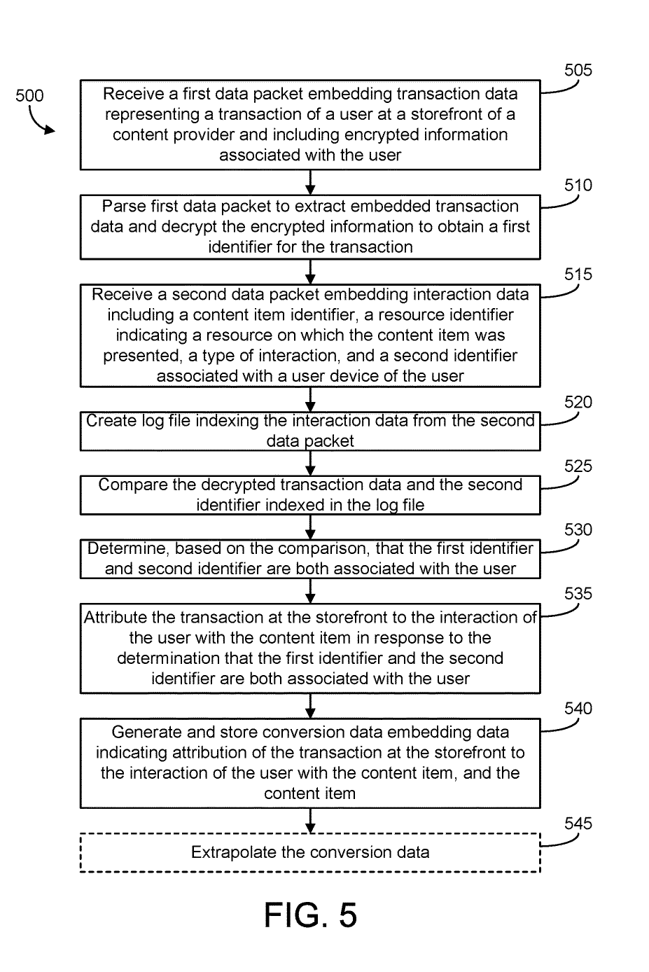

FIG. 5 is a flow diagram of a process 500 for attributing a plurality of conversions to a plurality of user interactions with a content item according to an illustrative implementation. Process 500 may be executed by, for example, offline conversion system 150 as described with reference to FIG. 1.

Process 500 includes receiving a first data packet embedding transaction data representing a transaction of a user at a storefront of a content provider and including encrypted information associated with the user (505). In one implementation, the first data packet is transmitted by a content provider at the storefront. The content provider may transmit the first data packet at given time intervals (e.g., daily, hourly, etc.), upon reaching a threshold number of transactions (e.g., 100, 1000, etc.), or in any other pattern. The transaction data may be encrypted using, for example, hashed PII as described above. The transaction data may generally include a user identifier and other transaction details that allow an offline conversion system 150 to identify content items associated with the transactions as described below. In one implementation, the user identifier is a user email address. Process 500 further includes parsing the first data packet to extract the embedded transaction data and decrypting the encrypted information to obtain a first identifier for the transaction (510).

Process 500 further includes receiving a second data packet embedding interaction data (515). The interaction data may generally represent user interactions with a content item on a resource. The interaction data may be captured for a given time period (e.g., one day, one week, etc.). The interaction data may generally include a content item identifier, a resource identifier indicating the resource on which the content item was presented, a type of interaction with the content item, and a second identifier associated with a user device of the user. Process 500 further includes creating a log file indexing the interaction data from the second data packet (520). Block 520 may generally include extracting the interaction data and identifying one or more fields from the interaction data (e.g., the second identifier) that allows offline conversion system 150 to attribute the interactions to the transactions.

Process 500 further includes comparing the decrypted transaction data and the second identifier indexed in the log file (525). Based on the comparison, it may be determined that the first identifier and the second identifier are both associated with the user (530). In one implementation, the comparison may include using the second identifier associated with a user device to identify an email address associated with the user device. The comparison may then simply include comparing the email addresses. In other implementations, any type of comparison may be used to verify if a particular user device identifier is related to a user identifier.

Process 500 includes attributing the transaction at the storefront to the interaction of the user with the content item (535). The attribution is made in response to the determination that the first identifier and second identifier are both associated with the user.

Process 500 includes generating and storing conversion data embedding data indicating attribution of the transaction at the storefront to the interaction of the user with the content item, and the content item (540). In various implementations, the transaction is attributed to a content item, or to a particular interaction with a content item. The attribution may generally identify any one or more desired actions taken by a user.

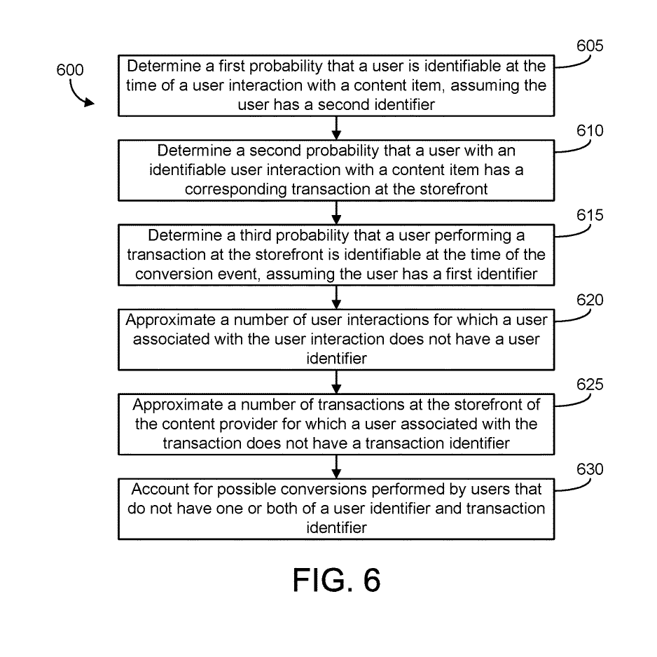

Process 500 may optionally include extrapolating the conversion data (545). As described above, for transaction data and interaction data that are not attributable to one another, the conversion data may be extrapolated to account for such data. Referring now to FIG. 6, an extrapolation process 600 is shown in greater detail.

Process 600 includes determining a first probability that a user is identifiable at the time of a user interaction with a content item, assuming that the user has a second identifier (605). In other words, at block 605, the probability that a user with an account is identifiable via the account at the time of an interaction is determined. At block 605, a total number of user interactions with content items is compared with a number of user interactions with a content item that occurred when the user was identifiable via the second identifier.

Process 600 further includes determining a second probability that a user with an identifiable user interaction with a content item has a corresponding transaction at the storefront (610). Process 600 further includes determining a third probability that a user performing a transaction at the storefront is identifiable at the time of the conversion event, assuming that the user has a first identifier (615). In other words, at block 615, the probability that a user with an account is identifiable via the account at the time of a transaction is determined. At block 615, a total number of transactions at the storefront is compared with a number of transactions at the storefront for which transaction data is available.

Process 600 further includes approximating a number of user interactions for which a user associated with the user interaction does not have a user identifier (620). This approximation may be based on the first probability. Process 600 further includes approximating a number of transactions at the storefront of the content provider for which a user associated with the transaction does not have a user identifier (625). This approximation may be based on the third probability. Process 600 further includes accounting for possible conversions performed by users that do not have one or both of a user identifier and transaction identifier (630). This approximation may be based on the second probability. Process 600 further includes combining the approximations to determine a total number of possible conversion events.

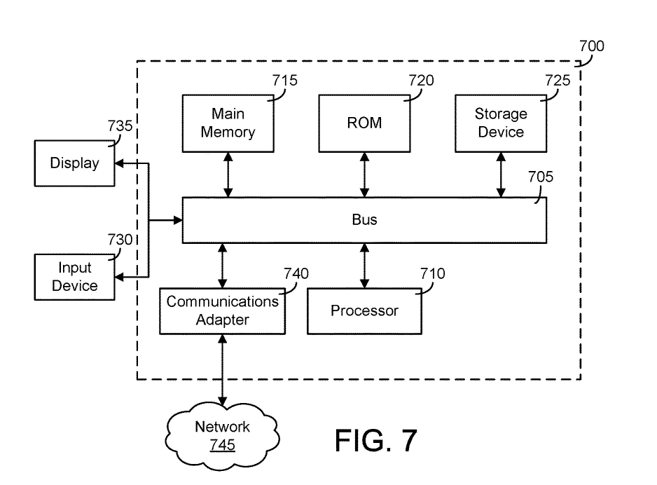

FIG. 7 illustrates a depiction of a computer system 700 that can be used, for example, to implement an illustrative user device 104, an illustrative content management system 108, an illustrative content provider device 106, an illustrative offline conversion system 150, and/or various other illustrative systems described in the present disclosure. Computing system 700 includes a bus 705 or other communication component for communicating information and a processor 710 coupled to bus 705 for processing information. Computing system 700 also includes main memory 715, such as a random access memory (RAM) or other dynamic storage device, coupled to bus 705 for storing information, and instructions to be executed by processor 710. Main memory 715 can also be used for storing position information, temporary variables, or other intermediate information during execution of instructions by processor 710. Computing system 700 may further include a read only memory (ROM) 720 or other static storage device coupled to bus 705 for storing static information and instructions for processor 710. A storage device 725, such as a solid state device, magnetic disk or optical disk, is coupled to bus 705 for persistently storing information and instructions.

Computing system 700 may be coupled via bus 705 to a display 735, such as a liquid crystal display, or active matrix display, for displaying information to a user. An input device 730, such as a keyboard including alphanumeric and other keys, may be coupled to bus 705 for communicating information, and command selections to processor 710. In another implementation, input device 730 has a touch screen display 735. Input device 730 can include a cursor control, such as a mouse, a trackball, or cursor direction keys, for communicating direction information and command selections to processor 710 and for controlling cursor movement on display 735.

In some implementations, computing system 700 may include a communications adapter 740, such as a networking adapter. Communications adapter 740 may be coupled to bus 705 and may be configured to enable communications with a computing or communications network 745 and/or other computing systems. In various illustrative implementations, any type of networking configuration may be achieved using communications adapter 740, such as wired (e.g., via Ethernet®), wireless (e.g., via WiFi®, Bluetooth®, etc.), pre-configured, ad-hoc, LAN, WAN, etc.

According to various implementations, the processes that effectuate illustrative implementations that are described herein can be achieved by computing system 700 in response to processor 710 executing an arrangement of instructions contained in main memory 715. Such instructions can be read into main memory 715 from another computer-readable medium, such as storage device 725. Execution of the arrangement of instructions contained in main memory 715 causes computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to implement illustrative implementations. Thus, implementations are not limited to any specific combination of hardware circuitry and software.

The systems and methods as described in the present disclosure may be implementable for any type of third-party content item (i.e., for any type of content item to be displayed on a resource). In one implementation, the content items may include advertisements. In one implementation, the content items may include any text, images, video, stories (e.g., news stories), social media content, links, or any other type of content provided by a third-party for display on the resource of a first-party content provider. The type of content item for which the methods herein are used for is not limiting.

Although an example processing system has been described in FIG. 7, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The terms “data processing apparatus” or “computing device” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
receiving, by one or more processors, a first data packet embedding transaction data representing a transaction of a user at a storefront of a content provider and including encrypted information associated with the user;
parsing, by the one or more processors, the first data packet to extract the embedded transaction data and decrypting, by the one or more processors, the encrypted information to obtain a first identifier for the transaction;
receiving, by the one or more processors, a second data packet embedding interaction data comprising a content item identifier, a resource identifier indicating a resource on which the content item was presented, a type of interaction, and a second identifier associated with a user device of the user;
creating, by the one or more processors, a log file indexing the interaction data from the second data packet;
comparing, by the one or more processors, the decrypted transaction data and the second identifier indexed in the log file;
determining, by the one or more processors, based on the comparison, that the first identifier and the second identifier are both associated with the user;
attributing, by the one or more processors, the transaction at the storefront to the interaction of the user with the content item in response to the determination that the first identifier and the second identifier are both associated with the user; and
generating and storing, by the one or more processors, conversion data embedding data indicating attribution of the transaction at the storefront to the interaction of the user with the content item, and the content item.

2. The method of claim 1, further comprising:
extrapolating, by the one or more processors, the conversion data to account for a number of transactions occurring at the storefront for which the first identifier or second identifier cannot be associated with a user; and
reporting, by the one or more processors, the extrapolated conversion data to the content provider.

3. The method of claim 2, wherein extrapolating the conversion data comprises:
determining a first probability that a user is identifiable at the time of a user interaction with a content item, assuming that the user has a second identifier;
determining a second probability that a user with an identifiable user interaction with a content item has a corresponding transaction at the storefront; and
determining a third probability that a user performing a transaction at the storefront is identifiable at the time of the conversion event, assuming that the user has a first identifier;
wherein the interaction data and the transaction data are used to determine the probabilities.

4. The method of claim 3, wherein the first probability is determined by comparing a total number of user interactions with a content item with a number of user interactions with a content item that occurred when the user was identifiable via a second identifier.

5. The method of claim 3, wherein the third probability is determined by comparing a total number of transactions at the storefront to a number of transactions at the storefront for which transaction data is available.

6. The method of claim 2, wherein extrapolating the conversion data further comprises:
approximating a number of user interactions for which a user associated with the user interaction does not have a user identifier;
approximating a number of transactions at the storefront of the content provider for which a user associated with the transaction does not have a transaction identifier; and
accounting for possible conversions performed by users that do not have one or both of a user identifier and transaction identifier.

7. The method of claim 1, wherein the encrypted information associated with the user comprises hashed personally identifiable information.

8. The method of claim 1, wherein the first identifier comprises an email address, and wherein the second identifier comprises an identifier received from a user device used in the interaction with the content item.

9. A system comprising:
at least one computing device operably coupled to at least one memory and configured to:
receive a first data packet embedding transaction data representing a transaction of a user at a storefront of a content provider and including encrypted information associated with the user;
parse the first data packet to extract the embedded transaction data and decrypt the encrypted information to obtain a first identifier for the transaction;
receive a second data packet embedding interaction data comprising a content item identifier, a resource identifier indicating a resource on which the content item was presented, a type of interaction, and a second identifier associated with a user device of the user;
create a log file indexing the interaction data from the second data packet;
compare the decrypted transaction data and the second identifier indexed in the log file;
determine, based on the comparison, that the first identifier and the second identifier are both associated with the user;
attribute the transaction at the storefront to the interaction of the user with the content item in response to the determination that the first identifier and the second identifier are both associated with the user; and
generate and store conversion data embedding data indicating attribution of the transaction at the storefront to the interaction of the user with the content item, and the content item.

10. The system of claim 9, the at least one computing device further configured to:
extrapolate the conversion data to account for a number of transactions occurring at the storefront for which the first identifier or second identifier cannot be associated with a user; and
report the extrapolated conversion data to the content provider.

11. The system of claim 10, wherein the at least one computing device is configured to extrapolate the conversion data by:
determining a first probability that a user is identifiable at the time of a user interaction with a content item, assuming that the user has a second identifier;
determining a second probability that a user with an identifiable user interaction with a content item has a corresponding transaction at the storefront; and
determining a third probability that a user performing a transaction at the storefront is identifiable at the time of the conversion event, assuming that the user has a first identifier;
wherein the interaction data and the transaction data are used to determine the probabilities.

12. The system of claim 11, wherein the at least one computing device is configured to determine the first probability by comparing a total number of user interactions with a content item with a number of user interactions with a content item that occurred when the user was identifiable via a second identifier.

13. The system of claim 11, wherein the at least one computing device is configured to determine the third probability by comparing a total number of transactions at the storefront to a number of transactions at the storefront for which transaction data is available.

14. The system of claim 10, wherein the at least one computing device is configured to extrapolate the conversion data by further:
approximating a number of user interactions for which a user associated with the user interaction does not have a user identifier;
approximating a number of transactions at the storefront of the content provider for which a user associated with the transaction does not have a transaction identifier; and
accounting for possible conversions performed by users that do not have one or both of a user identifier and transaction identifier.

15. The system of claim 9, wherein the encrypted information associated with the user comprises hashed personally identifiable information.

16. The system of claim 9, wherein the first identifier comprises an email address, and wherein the second identifier comprises an identifier received from a user device used in the interaction with the content item.

17. One or more computer-readable storage media having instructions stored thereon that, when executed by one or more processors, cause the one or more processors to execute operations comprising:
receiving a first data packet embedding transaction data representing a transaction of a user at a storefront of a content provider and including encrypted information associated with the user;
parsing the first data packet to extract the embedded transaction data and decrypting the encrypted information to obtain a first identifier for the transaction;
receiving a second data packet embedding interaction data comprising a content item identifier, a resource identifier indicating a resource on which the content item was presented, a type of interaction, and a second identifier associated with a user device of the user;
creating a log file indexing the interaction data from the second data packet;
comparing the decrypted transaction data and the second identifier indexed in the log file;
determining, based on the comparison, that the first identifier and the second identifier are both associated with the user;
attributing the transaction at the storefront to the interaction of the user with the content item in response to the determination that the first identifier and the second identifier are both associated with the user;
generating conversion data embedding data indicating attribution of the transaction at the storefront to the interaction of the user with the content item, and the content item;
extrapolating the conversion data to account for a number of transactions occurring at the storefront for which the first identifier or second identifier cannot be associated with a user; wherein the extrapolation comprises:
approximating a number of user interactions for which a user associated with the user interaction does not have a user identifier;
approximating a number of transactions at the storefront of the content provider for which a user associated with the transaction does not have a transaction identifier; and
accounting for possible conversions performed by users that do not have one or both of a user identifier and transaction identifier; and
reporting the extrapolated conversion data to the content provider.

18. The computer-readable storage media of claim 17, wherein extrapolating the conversion data comprises:
determining a first probability that a user is identifiable at the time of a user interaction with a content item, assuming that the user has a second identifier;
determining a second probability that a user with an identifiable user interaction with a content item has a corresponding transaction at the storefront; and
determining a third probability that a user performing a transaction at the storefront is identifiable at the time of the conversion event, assuming that the user has a first identifier;
wherein the interaction data and the transaction data are used to determine the probabilities.

19. The computer-readable storage media of claim 18, wherein the first probability is determined by comparing a total number of user interactions with a content item with a number of user interactions with a content item that occurred when the user was identifiable via a second identifier.

20. The computer-readable storage media of claim 18, wherein the third probability is determined by comparing a total number of transactions at the storefront to a number of transactions at the storefront for which transaction data is available.
